(19) United States
(12) Patent Application Publication
(10) Pub. No.: US 2013/0179594 A1
(43) Pub. Date: Jul. 11, 2013

(54) Method system and device for removing parts of computerized files that are sending through the internet and assembling them back at the receiving computer unit

(71) Applicants: Snir Revach, (US); Asaf Jeager, Kiryat Bialik (IL)

(72) Inventors: Snir Revach, (US); Asaf Jeager, Kiryat Bialik (IL)

(21) Appl. No.: 13/347,047

(22) Filed: Jan. 10, 2012

(51) Int. Cl. G06F 15/16

(52) U.S. Cl. 709/246

(57) ABSTRACT

The current invention renews, in method system and device, dedicated for the purpose of allowing faster transmission of computerized file in the internet, and between computers, by a device and system that enabling the dismantle of some of the files intended to be sent, coding the missing parts, and sending just partial parts of the file by the internet network communication platform, wherein, in the receiver side, the device of the present invention rebuilding the files, with the device dedicated with the software's and abilities for recognized the coding signals and rebuild and recovering the files to its original position, as in the present invention.

### BACKGROUND OF THE INVENTION

The current invention is at the field of networks transferring files. More particularly, the invention relates to a system and method and device, for improving file transfers in internet networks.

Today, considerable difficulty exists in transferring large files through internet network, such as the Internet or Intranet using E-mail or standard File Trans per Protocol (FTP). Many PC applications contain one or more components greater than 10 MB.

The transfer of large files lasting many minutes or even hours is susceptible to failure due to network congestions which last several seconds or minutes. Such failures are likely to necessitate the re-start of the entire the transfer. The transfer of smaller files is statistically less likely to encounter such problems and the penalty for having to re-start small transfer is relatively smaller.

Large transfers can also cause problems in inter-network access points where intermediate packet re-ordering and re-assembly may occur because there may be insufficient local storage available. As the information transfer requirements continue to increase, network congestion and poor service is experienced.

Accordingly, a need exists in information networks, e.g., the Internet, to optimally transfer large files without difficulty while protecting the service requirements of other users in the network. These can achieves by taking into consideration all users in the Internet, large or small files senders, so, one can expect that by reducing the heavy traffic at the internet, by reducing the files weight sending significantly, it will loosen the heavy traffic at the internet, and will enable better, faster and reliable communication system.

Prior art related to file transfers in computer networks includes the following:

U.S. Pat. No. 5,526,350 issued Jun. 11, 1996, discloses a telecommunications network having a plurality of switches for switching different types of traffic, such as audio data including voice data, fax and modem originated data, digital computer originated data and video data, A communication link connects a user's site to the network, and a bandwidth manager is provided to multiplex traffic of different types for transmission over the link. After transmission over the link, a complementary bandwidth manager is arranged to de-multiplex the traffic for application to the is respective switches. The bandwidth manager is arranged to dynamically allocate bandwidth to the different types of traffic, thereby optimizing the available bandwidth provided by the communications link.

There's a foreseeable need for an invention which includes a method, system and device that enables to reduce computerized files weights, before sending them through the internet, for example by disassemble the file to a parts that are to be sent, and to parts that are not meant to be sent by the internet, and by adding a coded list of the parts of the files that did not sent, will when the files arrives to the receiver side, the coded list enables an automatic reassembled of the files to their original stat, which enables is readable by the receiving side computerized systems.

### SUMMARY OF THE INVENTION

It is to be understood that both the foregoing general description and the following detailed description present embodiments of the invention and are intended to provide an overview or framework for understanding the nature and character of the invention as it is claimed. The accompanying drawings are included to provide a further understanding of the invention and are incorporated into and constitute a part of this specification. The drawings illustrate various embodiments of the invention and, together with the description, serve to explain the principles and operations of the invention but not to limit the invention to these descriptions only.

The present invention revile method system and device such as a machine, for removing parts of computerized files, at the user sending side, that are meant to be sent through the internet, and assembling them back at the receiving user computer unit, for the purpose of allowing lighten computerized files, and a better transportation at the internet communication system.

Wherein, the method components are performed by an independent unit, a device such as a machine, dedicated with software's and system of the present invention, sitting in the computer exit port, checking, identifying and verifying the data and the files that are sent from the computer towards the internet, while sending files over the Internet, and before the files are passes towards the internet, investigate the possibility of removing at list some of the generic parts of the files, and coding codes regarding the removing parts, consequently, what is sent eventually through the internet, is a partial the and codes of the removed parts, lowest weight the then the original one, which ease on the traffic of the internet, and enables a faster and easier communication system.

Wherein, when the partial files arrives by the internet communication system to the receiving computer, it is passes through the present invention device and machine, which read and recognizes the files, and the codes of the parts that departed from the files, and the device is recombining and recovering these files to theft original components, with the generic parts of the files, assembling them back in the reception at the target by the same unit device and machine of the present invention, that sits also before the computer in the receiving computer destination, wherein, eventually, the files are readable again in the receiving computer.

This application meant to reduce network traffic load, wherein, one of its implementations enables the method of the present invention by entered the file to a double array size, and then the machine will know the place of each data. The files will be separated to a Type\Row\Col and will be indication mark for the important files component.

At any time the system will know where each of one of them is located. As we know what the center of this media is, and we take of the other files and remember the place of each one, we take only the all data the and catalogue it.

After we disassemble the file and we know what data is in which place, we can make the signal in a one long row, wherein, this may achieve saving over then 25% bandwidth capacity, furthermore, it may achieve a high level security for VPN or organization company's networks

### BRIEF DESCRIPTION OF THE DRAWINGS

The added drawings in this patent request come in order to provide more visual understandings about the invention and are integral part of the request and the invention. The drawings describe different functions of the invention and, added to all the mentioned above, serve the purpose of explaining the principles and ways of operation and not, by any means, suppose to limit the invention solely to them.

FIG. 1 is a schematic flowchart description that shows an example, included in the current invention, of the method, the system and the device of the present invention.

FIG. 2 is a schematic description that shows an example, included in the current invention, of a table of a computerized logarithm and dedicated software's enabling the method, the system and the device of the present invention.

FIG. 3 is a schematic description that shows a table which is a continuant tables concluded from the data of the table of FIG. 2, of a computerized logarithm which can be performed by a dedicated software's, as one implementation possible in the method, the system and the device of the present invention.

FIG. 4 is a schematic description that shows a table of a computerized logarithm which can be performed by a dedicated software's, as one implementation possible in the method, the system and the device of the present invention.

FIG. 5 is a schematic description that shows a table of a computerized logarithm which can be performed by a dedicated software's, as one implementation possible in the method, the system and the device of the present invention.

### DESCRIPTION OF THE PREFERRED EMBODIMENTS

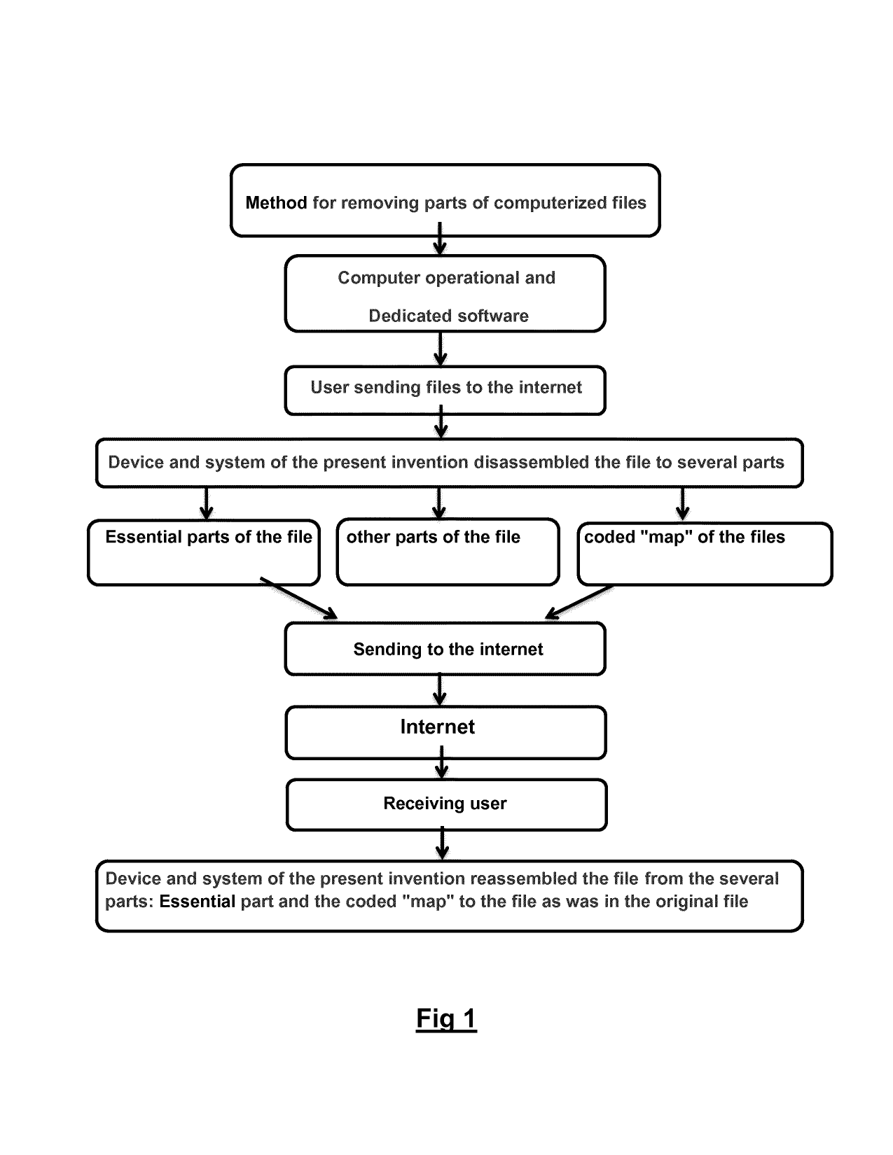

FIG. 1 is a schematic flowchart description that shows an example, included in the current invention, of the method, the system and the device of the present invention, wherein, the Method of the present invention designated by the system and device of the present invention to disassembled and remove parts of computerized files that are transfer through the internet, and assembling them back at the receiving computer unit, for the purpose of lighten the weight of files, for ease the heavy traffic of internet network communication, and for security and legal using files by authorized users, wherein the method comprising: a. system and device such as a machine, connecting to a computer, located between the computer and the internet connection, wherein; b. the system and device designated to analyzing the computerized files meant to be transfer through the internet network to some user receiver computer, or server, wherein; c. the system and device designated to separate the computerized files, at the user sending side, that are meant to be sent through the internet, to at list two types, and to add third type which is created by the system and the device, these three types are as fallow: (1) one type which are part of the files designated to be sent by the internet network; (2) second type are parts of the files designated not to be sent by the internet network; (3) third parts designated to be send by the internet network are the system and the device automatic creation of a coded pattern, that contain a coding of the parts of the second type that are not meant to be sent by the internet network, wherein; d. both type of the sending parts mentioned at this claim section c(1) and c(3), are sending through the internet network in a one file, or in pack of files, wherein; e. the files are sending through the internet to the receiving side of user computer and server, wherein, the same system and device of the present invention, is located at this receiving side too, wherein; f. the files arriving to the receiving side are assembled by the system and the device of the present invention, by recognition the coded pattern and converting them to the parts of the files that did not sent to the receiving side.

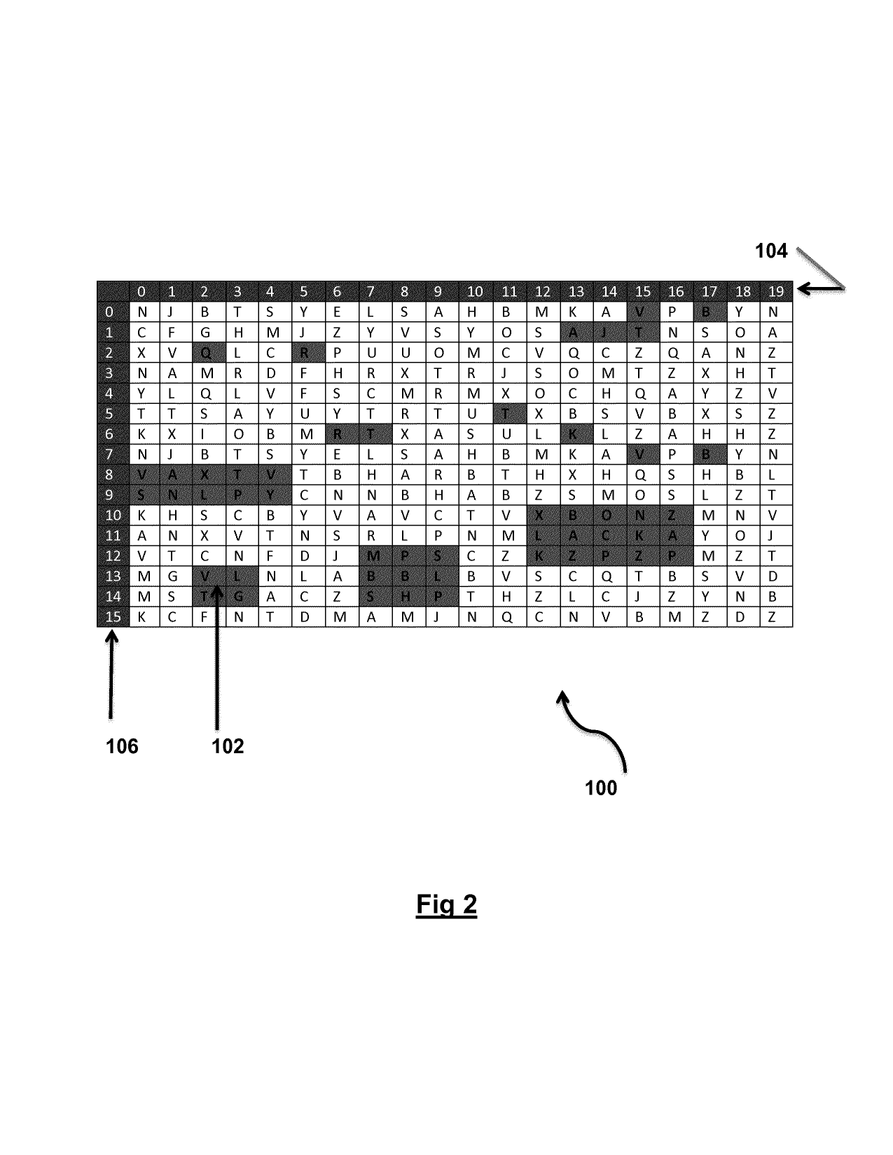

FIG. 2 is a schematic description that shows an example, included in the current invention, of a table 100 fitted to be performed in the scope of the present invention of “method system and device for removing parts of computerized files that are sending through the internet and assembling them back at the receiving computer unit” by a computerized logarithm and dedicated software's enabling the is method, the system and the device of the present invention. Wherein, the file data will be entered to a double array size and then the device and the machine will know the place of each data, that will enabled the file as in the example 100.

Wherein, the files will be separated to a Type, Row and Col. when, while the important files 102, in the table 100 which have vertical column 106 and the horizontal column 104, enabling to give to every part of the file, which is marked in the table deferent position, a specific defined location, its location respectively to the other file parts at the column, and its type and identity.

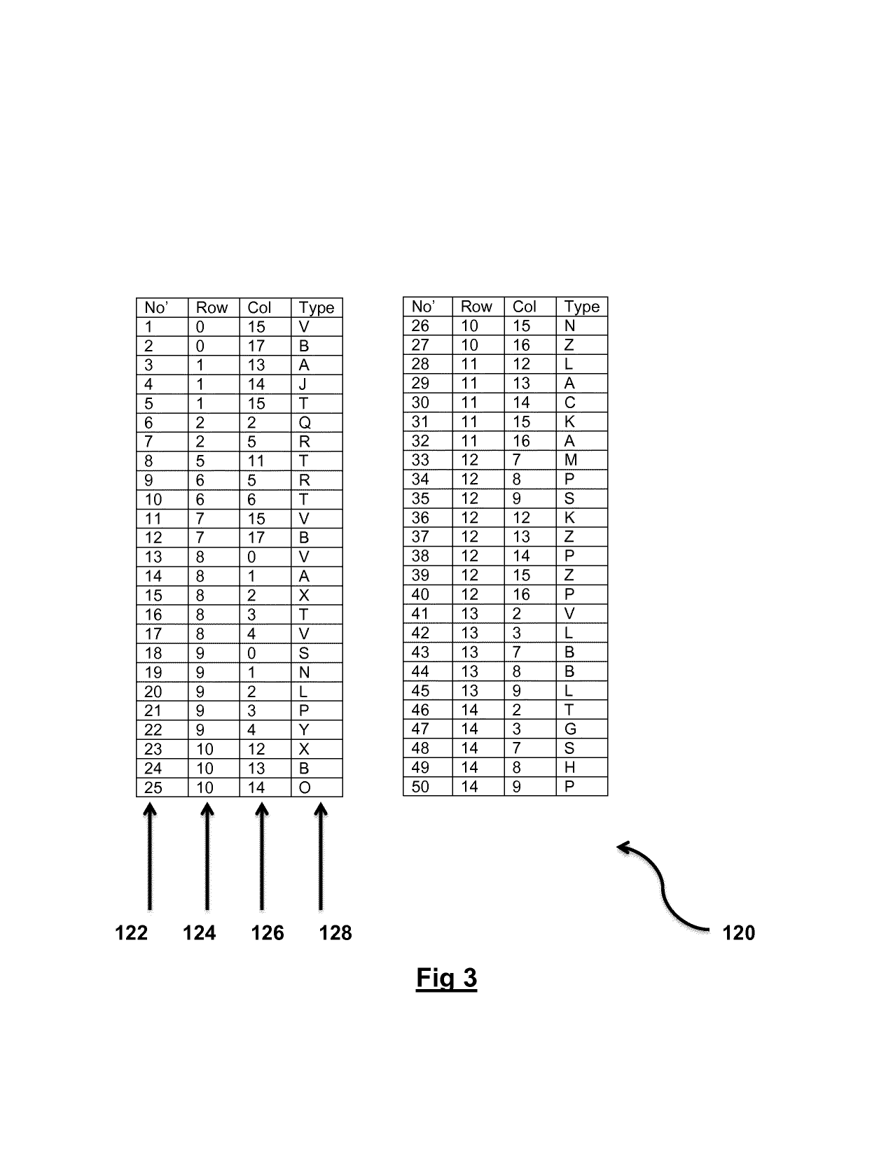

FIG. 3 is a schematic description that shows a table 120 which is a continuant tables concluded from the data of table 100 of FIG. 2, of a computerized logarithm which can be performed by a dedicated software's, as one implementation possible in the method, the system and the device of the present invention, wherein. In addition to FIG. 2 the system, device and machine will recognize the important files in the unit and separated them from the all-data files inside the unit. Let's say that we know what the center of this media is, and we take of the other files and remember the place of each one of them, for example, by tables organized by number 122, Col 124, Row 126 and Type 128, concluded from the data of the base table 100 of FIG. 2.

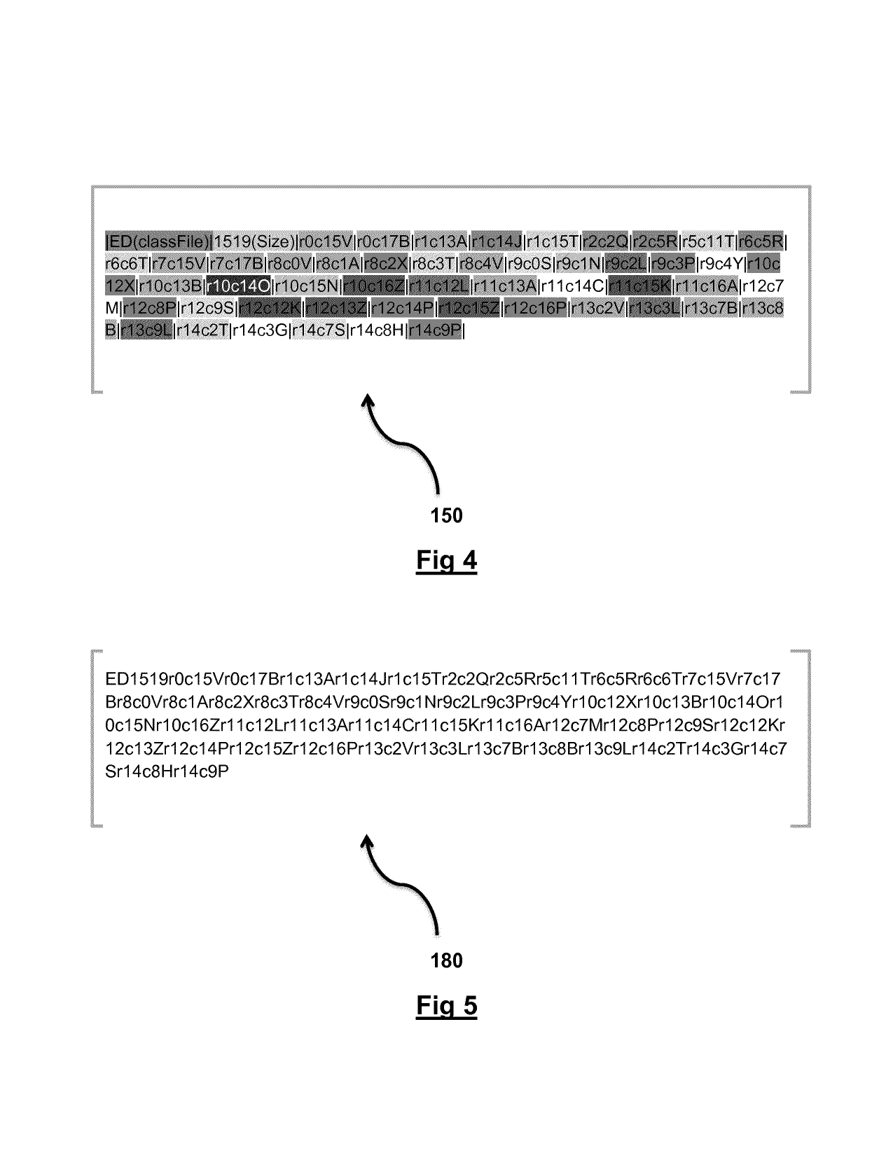

We take only the all-data file and catalogue them: After we disassemble the file and we know what data is in which place, we can make the signal in a one long row as in FIG. 4 and in FIG. 5.

FIG. 4 is a schematic description that shows a table of a computerized logarithm which can be performed by a dedicated software's, as one implementation possible in the method, the system and the device of the present invention. Presenting an example, of only the all-data file, after catalogue them, after disassemble the file and know what data is in which place, we can make the signal in a one long row as in FIG. 4 150, concluded from the data of the base table 100 of FIG. 2, and tables of FIG. 3 of the present invention.

FIG. 5 is a schematic description that shows a table of a computerized logarithm which can be performed by a dedicated software's, as one implementation possible in the method, the system and the device of the present invention. signal in a one long row as in FIG. 4 150, concluded from the data of the base table 100 of FIG. 2, and tables of FIG. 3 of the present invention.

Then we save over then 25% that are not traveling over on the line of the server. Wherein, because the disassemble data is now less than the original parts of were in the original file, the device and the machine have to recognizes and know all the parts location, type and size, and, how much place she need to save. Therefore, the device and the machine designated to remember the original size of the files and how much place she needs to save to the complete the file.

Another use for this machine is to secure file in a business place by this way, in each place that supply a network in his business, can place a machine like that next to the server for that a computer that not connected to this server, cannot receive the original file, he will get a garbage file.

The current invention intention is not to be limited to the samples above but to encircle all the embodiments within the range of the following claims:

1. Method for removing parts of computerized files that are transfer through the internet and assembling them back at the receiving computer unit, for the purpose of lighten the weight of files, for ease the heavy traffic of internet network communication, and for security and legal using files by authorized users, wherein the method comprising:
a. system and device such as a machine, connecting to a computer, located between the computer and the internet connection, wherein;
b. the system and device designated to analyzing the computerized files meant to be transfer through the internet network to some user receiver computer, or server, wherein;
c. the system and device designated to separate the computerized files, at the user sending side, that are meant to be sent through the internet, to at list two types, and to add third type which is created by the system and the device, these three types are as fallow: (1) one type which are part of the files designated to be sent by the internet network; (2) second type are parts of the files designated not to be sent by the internet network; (3) third parts designated to be send by the internet network are the system and the device automatic creation of a coded pattern, that contain a coding of the parts of the second type that are not meant to be sent by the internet network, wherein;
d. both type of the sending parts mentioned at this claim section c(1) and c(3), are sending through the internet network in a one file, or in pack of files, wherein;
e. the files are sending through the internet to the receiving side of user computer and server, wherein, the same system and device of the present invention, is located at this receiving side too, wherein;
f. the files arriving to the receiving side are assembled by the system and the device of the present invention, by recognition the coded pattern and converting them to the parts of the files that did not sent to the receiving side.

2. The claim as in claim 1, wherein:
a. the method components are performed by an independent unit, a device such as a machine, dedicated with software's and system of the present invention, sitting in the computer exit port, designated to perform an automatic checking, identifying and verifying of data and the files that are meant to be sent from the computer towards the internet, wherein;
B. before the files are passes towards the internet, the system and device investigating the possibility of removing at list some of the generic parts of the files, and;
c. coding codes regarding and relating each of the removing parts, consequently, what is sent eventually through the internet, is a partial files and, some codes of the removed parts; A lowest weight files then the original one, which ease on the internet heavy traffic, and enables a faster and easier communication system, and;
d. when the partial files arrives by the internet communication system to the receiving computer, it is passes through the present invention another device and machine located at this receiving side too, which read and recognizes the files, and the codes of the parts that departed from the files, and;
e. the device is recombining and recovering these files to theft original components, with the generic parts of the files, assembling them back in the reception at the target by the same unit device and machine of the present invention, that located also before the computer in the receiving computer destination, wherein, eventually, the files are readable again in the receiving computer.

3. The claim as in claim 1, wherein one of the method applications meant to reduce network traffic load, which, one of its implementations enables the method of the present invention by is entered the files to a double array size, and then the system and device will know the place of each data, wherein, the files will be separated to a Type\Row\Col and will be indication marks for the important files component, and at all times the system will know where each of one of them is located.

4. The claim as in claim 1, wherein the method of the present invention performed by the system and the device of the present invention, including automatic operation system and device and software and a dedicated software's which have the abilities of: a. abilities of recognition and identifying the generic parts of the files of each file and media; b. and take of the other parts of the files; c. and remember the place of each part of files, and coded it in a pattern; d. and, catalogue the all-data file; e. and, disassemble the file while we know what data located in which place; f. the system and software can make the signal, for example in a one long row.

5. The claim as in claim 1, wherein the method of the present invention is for the purposes of High level security for VPN or organization companies networks

6. System and device dedicated with software's, designated for removing parts of computerized files that are transfer through the internet, and assembling them back at the receiving computer unit, for the purpose of lighten the weight of files, for ease the heavy traffic of internet network communication, and for security and legal using of files by authorized users, wherein, the System and device comprising:
a. system and device such as a machine, connecting to a computer, located between the computer and the internet connection, wherein;
b. the system and device designated to analyzing the computerized files meant to be transfer through the internet network to some user receiver computer, or server, wherein;
c. the system and device designated to separate the computerized files, at the user sending side, that are meant to be sent through the internet, to at list two types, and to add third type which is created by the system and the device, these three types are as fallow: (1) one type which are part of the files designated to be sent by the internet network; (2) second type are parts of the files designated not to be sent by the internet network; (3) third parts designated to be send by the Internet network are the system and the device automatic creation of a coded pattern, that contain a coding of the parts of the second type that are not meant to be sent by the internet network, wherein;
d. both type of the sending parts mentioned at this claim section c(1) and c(3), are sending through the Internet network in a one file, or in pack of files, wherein;
e. the files are sending through the internet to the receiving side of user computer and server, wherein, the same system and device of the present invention, is located at this receiving side too, wherein;
f. the files arriving to the receiving side are assembled by the system and the device of the present invention, by recognition the coded pattern and converting them to the parts of the files that did not sent to the receiving side.

7. The claim as in claim 6, wherein:
a. the System and device components are performed by an independent unit, a device such as a machine, dedicated with software's and system of the present invention, sitting in the computer exit port, designated to perform an automatic checking, identifying and verifying of data and the files that are meant to be sent from the computer towards the internet, wherein;
B. before the files are passes towards the internet, the system and device investigating the possibility of removing at list some of the generic parts of the files, and;
c. coding codes regarding and relating each of the removing parts, consequently, what is sent eventually through the internet, is a partial files and, some codes of the removed parts; A lowest weight files then the original one, which ease on the internet heavy traffic, and enables a faster and easier communication system, and;
d. when the partial files arrives by the internet communication system to the receiving computer, it is passes through the present invention another device and machine located at this receiving side too, which read and recognizes the files, and the codes of the parts that departed from the files, and;
e. the device is recombining and recovering these files to theft original components, with the generic parts of the files, assembling them back in the reception at the target by the same unit device and machine of the present invention, that located also before the computer in the receiving computer destination, wherein, eventually, the files are readable again in the receiving computer.

8. The claim as in claim 6, wherein one of the System and device applications meant to reduce network traffic load, which, one of its implementations enables the System and device of the present is invention by entered the files to a double array size, and then the system and device will know the place of each data, wherein, the files will be separated to a Type\Row\Col and will be indication marks for the important files component, and at all times the system will know where each of one of them is located.

9. The claim as in claim 6, wherein the System and device of the present invention performed by the system and the device of the present invention, including automatic operation system and device and software and a dedicated software's which have the abilities of: a. abilities of recognition and identifying the generic parts of the files of each file and media; b. and take of the other parts of the files; c. and remember the place of each part of files, and coded it in a pattern; d. and, catalogue the all-data file: e. and, disassemble the file while we know what data located in which place; f. the system and software can make the signal, for example in a one long row.

10. The claim as in claim 6, wherein the System and device of the present invention is for the purposes of High level security for VPN or organization companies networks
